(19) United States
(12) Patent Application Publication
(10) Pub. No.: US 2006/0178894 A1
(43) Pub. Date: Aug. 10, 2006

(54) Disaster pairing method

(76) Inventors: Kelly J. Sedgewick, Naples, FL (US); Melanie R. Destout, Cape Coral, FL (US)

Correspondence Address: EDWARD M. LIVINGSTON, PA, 963 TRAIL TERRACE DRIVE, NAPLES, FL, 34103, US

(21) Appl. No.: 11/052,571

(22) Filed: Feb. 7, 2005

(51) Int. Cl. G06Q 99/00; G05B 19/418; G06F 9/46

(52) U.S. Cl. 705/1; 705/8

(57) ABSTRACT

A disaster pairing method has a disaster plan (1) for willing-and-able provider-household members (5) to help disaster-stricken recipient-household members (6) in paths of disasters. Standard procedures (3) for operating the disaster plan (1) include classifying and listing qualifications, capabilities, characteristics and preferences of the provider-household members (5) and the recipient-household members (6) in relation to children, number of people, ages, pets, addictions, religion, ethnicity, transportation and other factors selectively; and computer-listing provider-household members (5) and recipient-household members (6) by location and classification for instantaneous computer-matching. Sponsors and advertisers are solicited. Funding (10) is arranged selectively.

### BACKGROUND OF THE INVENTION

This invention relates to a method for pairing households for exchange assistance in surviving disasters such as hurricanes, tsunamis, floods, fires and terrorism.

In the wake of both natural and man-made disasters, people endure suffering that shelters and insurance do not ease. Residents of Florida and other southeastern states have suffered through numerous hurricanes with repeated damage each time. In the northern regions, families have been washed out of their homes by flood waters. Worldwide, disasters have caused similar suffering, sometimes repeatedly and always at the same human emotional toll.

Some professional weather analysts predict a 15-20-year cycle of the recurrent hurricane conditions suffered this year, with Charlie, Frances, Ivan and Jeanne. Orders to evacuate, and leave your home and everything that you own, sometimes including pets, only adds to the emotional burden and fear. Overcrowding, lack of food, privacy and sometimes even safety, what we really need is a warm home and comforting individuals who are willing to open their homes to others in order to survive the ravages of Nature and possibly human inflictions like 9/11.

Many families are happy to help a ravaged family, particularly in an exchange plan that could help them in return. Matching families in need to help each other can make a disaster experience bearable with human kindness. People who want to help, yet afraid of having no knowledge of whom they are letting in their home. They want to know at least something about those they might help. They also want to be known by others who might help them. Merely knowing at least something about a recipient and having freedom of choice prepares a giver of help for a wide selection of recipients. Being a potential recipient, a giver of help tends to prepare themselves for both giving and receiving help. A help-matching program can be socially constructive.

Prior art that is nearest known but very different in most aspects includes the following US patents on dating and matchmaking services.

| Pat. No. | Inventor | Disclosure Date |
|---|---|---|
| U.S. Pat. No. 5,086,394 | Shapira | Feb. 4, 1992 |
| U.S. Pat. No. 6,034,605 | March | Mar. 7, 2000 |
| U.S. Pat. No. 6,272,467 B1 | Durand et al. | Aug. 7, 2001 |
| U.S. Pat. No. 2003/0200137 A1 | Drummond | Oct. 23, 2003 |
| U.S. Pat. No. 2003/0200131 A1 | Gabbert | Oct. 23, 2003 |
| U.S. Pat. No. 2003/0233270 A1 | Buss | Dec. 18, 2003 |
| U.S. Pat. No. 6,681,223 B1 | Sundaresan | Jan. 20, 2004 |
| U.S. Pat. No. 6,735,568 B1 | Buckwalter et al. | May 11, 2004 |

### SUMMARY OF THE INVENTION

Objects of patentable novelty and utility taught by this invention are to provide a disaster pairing method which:

eases the mental anguish, fear, suffering and uncertainty of fleeing from area disasters such as hurricanes, tsunamis, floods, fires and terrorism;

improves societal stability;

decreases costs for insurance and taxes for adjustments to area disasters;

saves lives of people and their pets; and

builds friendships and pleasures from disaster hardships.

This invention accomplishes these and other objectives with a disaster pairing method having a plan for willing-and-able households to help disaster-stricken households in paths of disasters. Objectives, standards and rules are prepared for operating the plan. A membership organization of participating households is planned. Suitable employees are engaged. Funding is arranged. Sponsors and advertisers are solicited. A computerized operating system with a database is established. Members are recruited. The plan is activated.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF DRAWINGS

This invention is described by appended claims in relation to description of a preferred embodiment with reference to the following drawings which are explained briefly as follows:

FIG. 1 is a flow diagram for the disaster pairing method;

FIG. 2 is a functional diagram for the disaster pairing method; and

FIG. 3 is a functional diagram for standard procedures of the disaster pairing method.

### DESCRIPTION OF PREFERRED EMBODIMENT

A description of the preferred embodiment of this invention follows a list of numbered terms which designate its features with the same numbers on the drawings and in parentheses throughout the description and throughout the patent claims.

| | | | |
|---|---|---|---|
| 1. | Disaster plan | 18. | Soliciting sponsors and |
| | | | advertisers |
| 2. | Functional organization | 19. | Coordinating with |
| 3. | Standard organization | | government agencies |
| 4. | Database | 20. | Adapting for government |
| | | | disaster aid |
| 5. | Provider-household members | 21. | Searching for provider- |
| 6. | Recipient-household members | | household homes |
| 7. | Prevention methods | 22. | Providing travel direction |
| 8. | Sponsors | 23. | Establishing provider |
| | | | standards |
| 9. | Advertisers | 24. | Classifying and listing |
| 10. | Funding | | provider qualifications |
| 11. | Travel direction | 25. | Establishing membership |
| | | | standards |
| 12. | Engaging employees | 26. | Classifying and listing |
| 13. | Mapping disaster paths | | recipient qualifications |
| 14. | Mapping escape routes | 27. | Computer-listing |
| 15. | Compatibility-matching members | | members by location |
| 16. | Qualifying disaster severity | | and classification |
| 17. | Establishing damage-prevention | | |
| | guides | | |

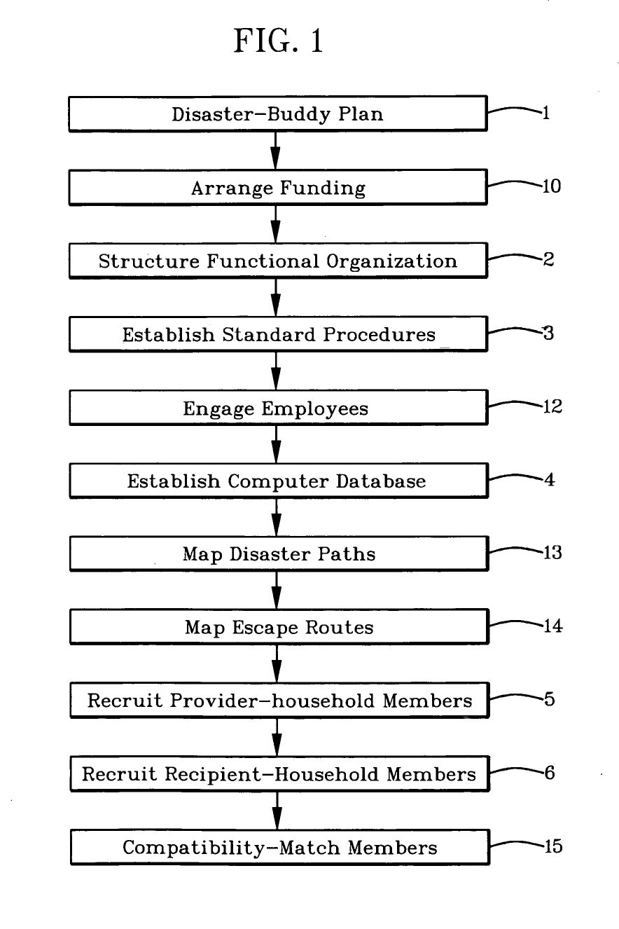

As shown diagrammatically by a flow chart in FIG. 1, a disaster pairing method is comprised of steps that can include:

providing a disaster buddy plan (1) for willing-and-able provider households to assist disaster-stricken recipient households in paths of disasters;

arranging funding (10);

structuring a functional organization (2) for management of the plan (1);

establishing standard procedures (3) for operating the plan;

engaging suitable employees (12) for executing the plan;

computerizing a database (4) for the plan;

mapping probable disaster paths (13);

mapping plausible escape routes (14);

recruiting provider-household members (5) in the plausible escape routes;

recruiting probable recipient-household members (6); and

compatibility-matching the recipient-household members (6) with the provider household members (5) during disasters in accordance with the plan (15).

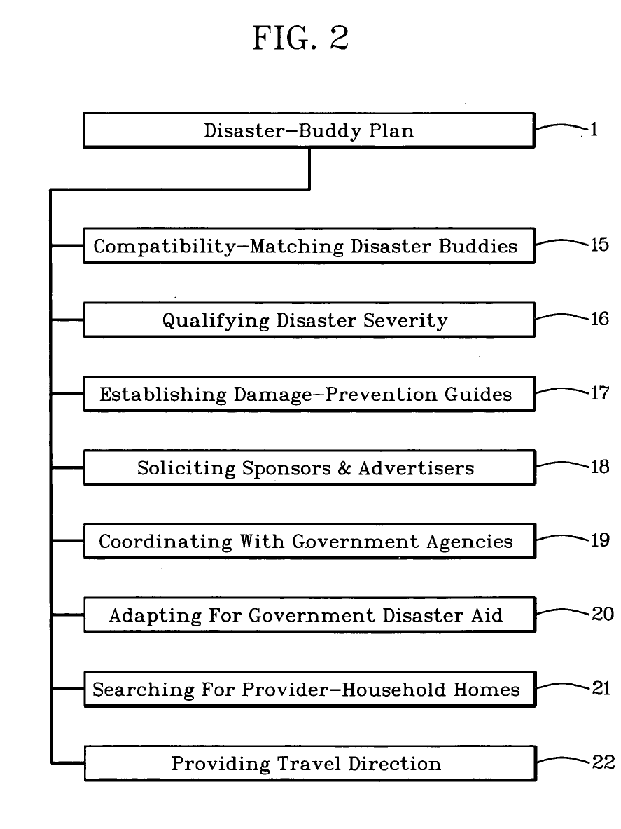

As shown diagrammatically by a functional chart in FIG. 2, the disaster-buddy plan (1) can include:

the compatibility-matching of disaster buddies (15);

qualifying disaster severity (16) for activating assistance;

establishing damage-prevention guides (17) that are plausible and affordable;

soliciting sponsors and advertisers (18) for financial and functional assistance;

coordinating with government agencies (19);

adapting for government disaster aid (20);

searching for provider-household homes (21) actively in possible escape routes; and

providing travel direction (22) and information on travel conditions during disasters.

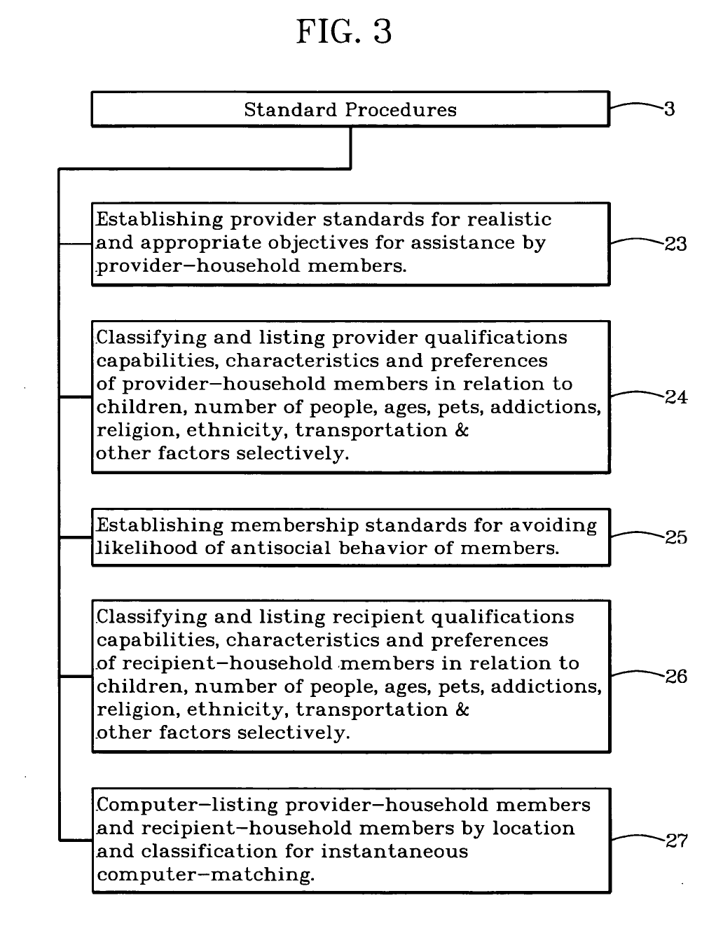

As shown diagrammatically by a functional chart in FIG. 3, the standard procedures (3) for operating the disaster-buddy plan (1) can include:

establishing provider standards (23) for realistic and appropriate objectives for assistance by the provider-household members (5);

classifying and listing provider qualifications (24), capabilities, characteristics and preferences of provider-household members (5) in relation to children, number of people, ages, pets, addictions, religion, ethnicity, transportation and other factors selectively;

establishing membership standards (25) for preventing likelihood of antisocial behavior of members;

classifying and listing recipient qualifications (26) for determining needs, likes and dislikes of probable recipient-household members (6) in relation to children, number of people, ages, pets, addictions, religion, ethnicity, transportation and other factors selectively; and

computer-listing provider-household members (5) and recipient-household members (6) by location and classification for instantaneous computer-matching.

The disaster-buddy plan (1) includes arranging funding (10). The funding (10) can include qualifying as a non-profit institution and operating with a safety-margin profit for assuring reliable solvency by charging members for coordinating interactive assistance from disaster and soliciting contributions from advertisers and individuals selectively. Optionally, the funding (10) can include qualifying as a for-profit company and operating profitably by charging members for coordinating interactive assistance from disaster.

A new and useful disaster pairing method having been described, all such foreseeable modifications, adaptations, substitutions of equivalents, mathematical possibilities of combinations of parts, pluralities of parts, applications and forms thereof as described by the following claims and not precluded by prior art are included in this invention.

What is claimed is:

1. A disaster pairing method comprised of the following steps:
providing a disaster plan for participant host households to assist disaster-stricken recipient households in paths of disasters;
structuring a functional organization for management of the plan;
establishing standard procedures for operating the plan;
engaging suitable employees for executing the plan;
computerizing a database for the plan;
mapping probable disaster paths;
mapping plausible escape routes;
recruiting provider-household members in the plausible escape routes;
recruiting probable recipient-household members; and
compatibility-matching the recipient-household members with the provider household members during disasters in accordance with the plan.

2. The method of claim 1 in which:
the disaster plan includes qualifying severity of disaster for activating assistance.

3. The method of claim 1 in which:
the standard procedures for operating the disaster plan include
establishing provider standards for realistic and appropriate objectives for assistance by the provider-household members;
classifying and listing provider qualifications, capabilities, characteristics and preferences of provider-household members in relation to children, number of people, ages, pets, addictions, religion, ethnicity, transportation and other factors selectively;
establishing membership standards for preventing likelihood of antisocial behavior of members;
classifying and listing recipient qualifications for determining needs, likes and dislikes of probable recipient-household members in relation to children, number of people, ages, pets, addictions, religion, ethnicity, transportation and other factors selectively; and
computer-listing provider-household members and recipient-household members by location and classification for instantaneous computer-matching.

4. The method of claim 1 in which:
the disaster plan includes establishing and listing plausible and affordable prevention methods for preventing damage from disasters.

5. The method of claim 1 in which:
the disaster plan includes soliciting sponsors and advertisers for functional and financial assistance.

6. The method of claim 1 in which:
the disaster plan includes coordinating activities with applicable government organizations.

7. The method of claim 1 in which:
the disaster plan includes arranging funding.

8. The method of claim 7 in which:
the funding includes qualifying as a non-profit institution and operating with a safety-margin profit for assuring reliable solvency by charging members for coordinating interactive assistance from disaster and soliciting contributions from advertisers and individuals selectively.

9. The method of claim 7 in which:
the funding includes qualifying as a for-profit company and operating profitably by charging members for coordinating interactive assistance from disaster.

10. The method of claim 1 in which:
the disaster plan includes adapting to requirements for receiving government aid that might be available for disaster assistance.

11. The method of claim 1 in which:
the disaster plan includes actively searching for provider-household homes in disaster-escape routes.

12. The method of claim 1 in which:
recruiting membership includes publicizing and advertising the plan.

13. The method of claim 1 in which:
the disaster plan includes providing travel direction and current travel information in the routes of escape.

14. A disaster pairing method is comprised of the following steps:
providing a disaster plan for willing-and-able provider households to assist disaster-stricken recipient households in paths of disasters;
qualifying severity of disaster for activating assistance;
establishing and listing plausible and affordable prevention methods for preventing damage from disasters;
structuring a functional organization for management of the plan;
establishing standard procedures for operating the plan;
the standard procedures for operating the disaster plan include
establishing realistic and appropriate objectives for assistance by the
provider-household members;
classifying and listing qualifications, capabilities, characteristics and preferences of provider-household members in relation to children, number of people, ages, pets, addictions, religion, ethnicity, transportation and other factors selectively;
classifying and listing needs, likes and dislikes of probable recipient-household members in relation to children, number of people, ages, pets, addictions, religion, ethnicity, transportation and other factors selectively;
computer-listing provider-household members and recipient-household members by location for instantaneous computer-matching;
engaging suitable employees for executing the plan;
computerizing a database for the plan;
mapping probable disaster paths;
mapping plausible escape routes;
recruiting provider-household members in the plausible escape routes;
recruiting probable recipient-household members;
compatibility-matching recipient-household members with provider household members during disasters in accordance with the plan; and
providing travel direction and current travel information in the escape routes.
